(19) United States
(12) Patent Application Publication
(10) Pub. No.: US 2025/0149595 A1
(43) Pub. Date: May 8, 2025

(54) LITHIUM SECONDARY BATTERY

(71) Applicant: TOYOTA JIDOSHA KABUSHIKI KAISHA, Toyota-shi (JP)

(72) Inventor: Junko AMANO, Toyota-shi (JP)

(73) Assignee: TOYOTA JIDOSHA KABUSHIKI KAISHA, Toyota-shi (JP)

(21) Appl. No.: 18/773,991

(22) Filed: Jul. 16, 2024

(30) Foreign Application Priority Data
Nov. 2, 2023 (JP) 2023-188451

(51) Int. Cl. H01M 4/66; H01M 4/02; H01M 4/75; H01M 10/0525

(52) U.S. Cl. CPC H01M 4/662; H01M 4/75; H01M 10/0525; H01M 2004/021; H01M 2004/027

(57) ABSTRACT

The lithium secondary battery includes a positive electrode, a separator, a negative electrode, and an electrolytic solution. The negative electrode includes a current collector sheet. The thickness of the current collector sheet is 10 μm to 20 μm. The current collector sheet has a plurality of recessed portions. In each of the recesses, assuming that a diameter on a surface is a, a center-to-center distance with another recess closest to the recess is b, and a depth is d, and assuming that an average value of the diameter a is A, an average value of the center-to-center distance b is B, an average value of the depth d is D, and a thickness of the current collection sheet is C, the following expressions (1), (2), and (3): 0.05≤A≤0.18 (1), B≤0.18 (2), and D/C≥3/5 (3) are satisfied.

### CROSS-REFERENCE TO RELATED APPLICATION

This application claims priority to Japanese Patent Application No. 2023-188451 filed on Nov. 2, 2023, incorporated herein by reference in its entirety.

### BACKGROUND

### 1. Technical Field

The present disclosure relates to a lithium secondary battery.

### 2. Description of Related Art

Japanese Unexamined Patent Application Publication No. 2019-160776 (JP 2019-160776 A) discloses that a plurality of protrusions is provided on each of a first surface and a second surface of a negative electrode current collector.

### SUMMARY

In a negative electrode of a lithium secondary battery, a dissolution deposition reaction is used. That is, during charging, lithium metal is deposited from the electrolytic solution. During discharging, the lithium metal dissolves in the electrolytic solution. An increase in energy density due to the use of the dissolution deposition reaction is expected. However, there is room for improvement in cycle durability of the lithium secondary battery.

An object of the present disclosure is to improve the cycle durability of a lithium secondary battery.

Hereinafter, technical configurations and effects of the present disclosure will be described. Here, the mechanism of action of the present specification includes an assumption. The mechanism of action does not limit the technical scope of the present disclosure.

1. A lithium secondary battery includes: a positive electrode; a separator; a negative electrode; and an electrolytic solution. The negative electrode includes a current collector sheet. The thickness of the current collector sheet is 10 μm to 20 μm. The current collector sheet includes a plurality of recesses. Assuming that the diameter of each of the recesses on a surface is a (mm), the center-to-center distance between each of the recesses and another recess most adjacent to the recess is b (mm), and the depth of each of the recesses is d (μm), the average value of the diameters a (mm) is A (mm), the average value of the center-to-center distances b (mm) is B (mm), the average value of the depths d (μm) is D (μm), and the thickness of the current collector sheet is C (μm), relationships of Expressions (1), (2), and (3) are satisfied:

$$0.05 \leq A \leq 0.18 , \qquad ( 1 )$$

$$B \leq 0.18 , and \qquad ( 2 )$$

$$D / C \geq 3 / 5. \qquad ( 3 )$$

In the lithium secondary battery, during charging, lithium metal may be deposited from a plurality of origins on the negative electrode to form a plurality of deposits. Each of the deposits may cause expansion of the negative electrode, which may cause a decrease in capacity retention rate. The expansion of the negative electrode means that the total volume including the volume of the negative electrode and the volume of the deposited lithium metal increases. As each of the deposits grows and becomes larger, a part of the deposit falls off in the electrolytic solution. The lithium metal that has fallen off may cause an irreversible capacity. The capacity retention rate of the lithium secondary battery is decreased due to the expansion of the negative electrode and an increase in the deposits of the lithium metal that fall off in the electrolytic solution, and cycle durability is decreased.

For example, JP 2019-160776 A discloses that the deposition of the lithium metal is controlled by providing a plurality of protrusions on each of the first surface and the second surface of the negative electrode current collector. However, the process of providing the protrusions on each of the first surface and the second surface of the negative electrode current collector is complicated. Since the protrusions are made of a resin material, a surface of the protrusion does not serve as the deposition origin of lithium metal. On the other hand, in the present disclosure, the deposition of the lithium metal is controlled by using the current collector sheet including the recesses. Inner walls of the recesses serve as deposition origins, and the process of providing the recesses is simple.

In the present disclosure, the cycle durability of the lithium secondary battery can be improved. This can be realized due to the current collector sheet that includes the recesses and in which the recesses are arranged to satisfy the Expressions (1), (2), and (3). That is, since the current collector sheet includes the recesses, lithium metal is deposited also from the inner walls of the recesses, and the number of deposition origins appropriately increases. When the number of deposition origins appropriately increases, the current density of each of the deposits decreases, and the deposits deposited from the respective deposition origins can be made to grow with high density. When the density of each of the deposits is high, the falling off of the deposits is suppressed. Since the deposits grow with high density and grows from the origins appropriately adjacent to each other, the expansion of the negative electrode is suppressed even after the deposits are formed into a continuous deposit due to subsequent growth. It is presumed that the growth of the deposits from the origins appropriately adjacent to each other is made possible when the recesses satisfy the relationships of Expressions (1), (2), and (3).

2. The lithium secondary battery according to “1” may include, for example, the following configuration. The current collector sheet is a copper foil or a copper alloy foil.

3. The lithium secondary battery according to “1” or “2” may include, for example, the following configuration. The aperture ratio of the surface of the current collector sheet is 20% to 45%.

Since the aperture ratio of the surface is 20% or more, the number of origins at which lithium metal is deposited increases, and the current density of the deposit deposited from each of the origins is expected to decrease. In addition, since the aperture ratio of the surface is 45% or less, lithium metal is expected to be deposited from the origins appropriately adjacent to each other.

4. The lithium secondary battery according to “1” or “2” is, for example, an anode-free battery. The anode-free battery is expected to contribute to improvement in capacity.

5. In the lithium secondary battery according to “1”, for example, the current collector sheet is a copper foil or a copper alloy foil, and the aperture ratio of the surface is 20% to 45%.

Hereinafter, embodiments of the present disclosure (which may be abbreviated as “the present embodiments” below) and examples of the present disclosure (which may be abbreviated as “the present examples” below) will be described. Note that the present embodiments and the present examples do not limit the technical scope of the present disclosure. The present embodiments and the present examples are illustrative in all respects. The present embodiments and the present examples are non-restrictive. The technical scope of the present disclosure includes all changes within the meaning and the scope that are equivalent to the description of CLAIMS. For example, extracting arbitrary configurations from the present embodiment and present example and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a lithium secondary battery in the present embodiment;

FIG. 2 is a conceptual diagram showing an example of a current collector sheet in the present embodiment;

FIG. 3 is a conceptual diagram showing another example of the current collector sheet in the present embodiment;

FIG. 4A is a conceptual diagram showing a charging and discharging process near the current collector sheet of the lithium secondary battery in the present embodiment;

FIG. 4B is a conceptual diagram showing a charging and discharging process near the current collector sheet of the lithium secondary battery in the present embodiment;

FIG. 4C is a conceptual diagram showing a charging and discharging process near the current collector sheet of the lithium secondary battery in the present embodiment; and

FIG. 5 is Table 1 showing an arrangement pattern and evaluation results of the recesses of the current collector sheet.

### DETAILED DESCRIPTION OF EMBODIMENTS

### Description of Term

Terms used in the present specification will be described. Terms not described here can be described each time they are used in the present specification.

A numerical range such as “m % to n %” includes upper and lower limits unless otherwise specified. That is, “m % to n %” represents a numerical range of “m % or more and n % or less”. “m % or more and n % or less” includes “more than m % and less than n %”. “Or more” and “or less” are represented by an inequality sign “≤” with an equal sign. “More” and “less” are represented by an inequality sign “<” excluding an equal sign. A numerical value arbitrarily selected from a numerical range may be adopted as a new upper or lower limit. For example, a new numerical range may be set by arbitrarily combining a numerical value within a numerical range with a numerical value described in another part, table, or drawing in the present specification.

All numerical values are modified by the term “about”. The term “about” can mean, for example, ±5%, ±3%, ±1%, and the like. All numerical values can be approximate values that can change depending on the mode of use of the technique of the present disclosure. All numerical values can be expressed in significant figures. The measured value can be an average value in a plurality of measurements unless otherwise specified. The number of times of measurement may be 3 or more, 5 or more, or 10 or more. Generally, it is expected that the reliability of the average value will be improved as the number of times of measurement increases. The measured value can be rounded off to the nearest integer based on number of digits of the significant figures. The measured value can include, for example, an error that occurs due to the detection limit of the measuring device or the like.

A “state of charge (SOC)” indicates a percentage of a charge capacity of the battery at that point in time with respect to a full charge capacity of the battery.

The “lithium secondary battery” refers to a battery in which a negative electrode reaction includes a dissolution deposition reaction of lithium metal. For example, the dissolution deposition reaction of the lithium metal may account for 1% to 100%, 25% to 100%, 50% to 100%, or 75% to 100% of the negative electrode capacity. The negative electrode capacity represents a reversible capacity. For example, in an SOC of 1% to 100%, 1% to 75%, 1% to 50%, or 1% to 25%, lithium metal may be deposited on the negative electrode. The lithium metal may be completely dissolved in the electrolytic solution in an SOC of 0% (complete discharge). In the SOC of 0%, a part of the lithium metal may remain on the negative electrode.

In general, the deposition of lithium metal in a lithium-ion secondary battery may be an irreversible capacity. The deposition of lithium metal in the lithium-ion secondary battery is, for example, an unintended reaction. The deposition of lithium metal in a lithium-ion secondary battery may occur, for example, in an abnormality, an erroneous use, or the like.

In the “anode-free battery”, lithium metal is not present in the negative electrode before the first charging (after assembly, before the first charging). The anode-free battery is assembled in a state where the negative electrode does not contain lithium metal (negative electrode active material). At the time of the initial charging, lithium is supplied from the positive electrode to the negative electrode, and thus lithium metal is first deposited on the negative electrode. In the anode-free battery, the lithium metal may be completely dissolved at the time of complete discharge.

### Lithium Secondary Battery

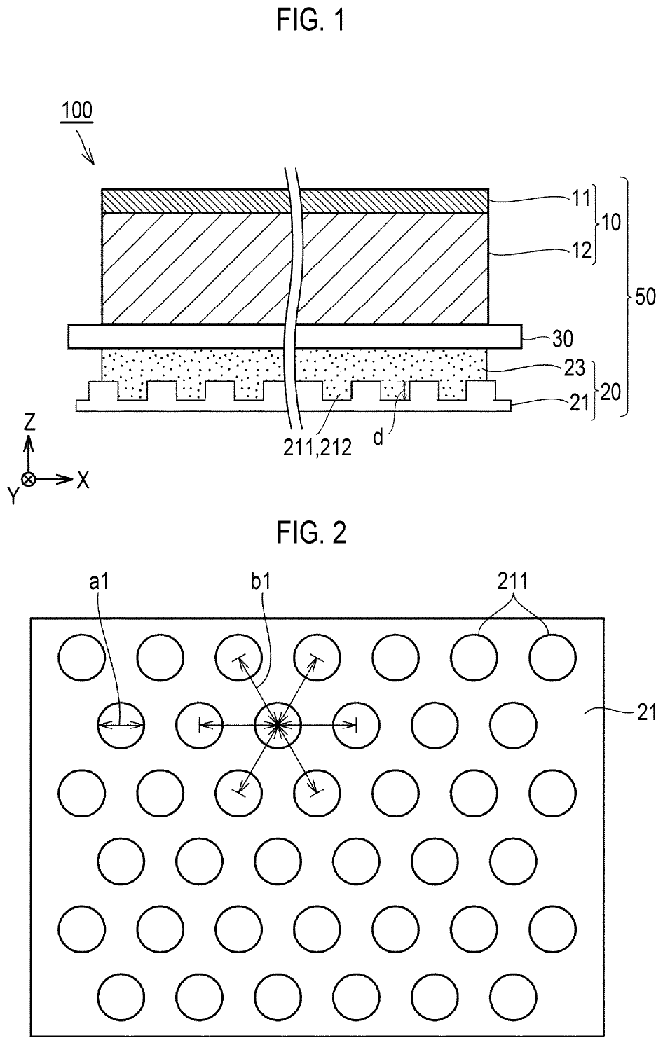

FIG. 1 is a conceptual diagram showing a lithium secondary battery in the present embodiment. The battery 100 includes the power generation element 50 and an electrolytic solution (not shown).

### Exterior Body

The battery 100 may include an exterior body (not shown). The exterior body member may house the power generation element 50 and the electrolytic solution. The exterior body may have any form. The exterior body may be, for example, a pouch or the like made of a metal foil laminated film or may be a case or the like made of a metal. The case may have any shape. The case may be, for example, cylindrical, rectangular, flat, or coin-shaped. The exterior body may include, for example, Al. The exterior body may house, for example, one power generation element 50 or may house a plurality of power generation elements 50. The power generation elements 50 may form, for example, a series circuit or a parallel circuit. In the exterior body, the power generation elements 50 may be stacked in the thickness direction of the battery 100.

### Power Generation Element

The power generation element 50 includes a positive electrode 10, a negative electrode 20, and a separator 30. The separator 30 is arranged between the positive electrode 10 and the negative electrode 20. The power generation element 50 may have any form. The power generation element 50 may have a bipolar structure or a monopolar structure. The power generation element 50 may be, for example, a laminated type. For example, the power generation element 50 may be formed by alternately laminating the positive electrode 10 and the negative electrode 20 with the separator 30 interposed between the positive electrode 10 and the negative electrode 20. For example, the band-shaped separator 30 is folded in a zigzag manner, and the positive electrodes 10 and the negative electrodes 20 may be alternately disposed each time the separator 30 is folded back. The power generation element 50 may be a wound type, for example. For example, the positive electrode 10, the negative electrode 20, and the separator 30 may all be in a band shape. For example, the positive electrode 10, the separator 30, and the negative electrode 20 may be stacked in this order to form a laminate. The power generation element 50 may be formed by winding the laminate in a spiral shape. The wound type power generation element 50 may be molded into a flat shape after winding.

### Negative Electrode

The negative electrode 20 includes a current collector sheet 21. In the negative electrode 20 in the SOC larger than 0%, a Li metal layer 23 on the current collector sheet 21 is further included. The thickness of the Li metal layer 23 also increases or decreases with an increase or decrease in the SOC. The Li metal layer 23 may have a configuration in which a plurality of deposits is present, or may have a configuration in which the plurality of deposits are continuously integrated.

The current collector sheet 21 has conductivity. The current collector sheet 21 can function as a current collector, and examples thereof include a foil and a film. The thickness of the current collector sheet 21 is 10 μm to 20 μm, and may be, for example, 12 μm to 18 μm. The material of the current collector sheet 21 may be any conductive material, such as a metal or an alloy, as long as the material is not a lithium metal or a lithium alloy. The conductive material is preferably a material that does not react with lithium. Such a conductive material may include, for example, at least one selected from the group consisting of copper (Cu), nickel (Ni), iron (Fe), zinc (Zn), lead (Pb), silver (Ag), and gold (Au). Examples of the alloy include a copper alloy and a stainless steel (SUS). The current collector sheet 21 is, for example, a copper foil or a copper alloy foil.

The current collector sheet 21 has a plurality of recesses. In each of the recesses, a diameter on a surface is represented by a (mm), a center-to-center distance between the recess and another recess most adjacent to the recess is represented by b (mm), and a depth is represented by d (μm). An average value of the diameter a (mm) is represented by A (mm), an average value of the center-to-center distance b (mm) is represented by B (mm), and an average value of the depth d (μm) is represented by D (μm). Further, a thickness of the current collector sheet is represented by C (μm). The relationships of Expressions (1), (2), and (3): 0.05≤A≤0.18 (1), B≤0.18 (2), and D/C≥3/5 (3) are satisfied. In the above, the average value is an arithmetic average.

The arrangement pattern of the recesses is not limited as long as the arrangement pattern satisfies the Expressions (1), (2), and (3). The shape of the surface of the recesses is not limited, and is, for example, circular, elliptical, or rectangular. The diameter of the recess is a circular diameter when the shape of the recess on the surface is circular, and is a minimum circular diameter that includes the shape of the surface when the shape is not circular. In addition, the center of the recess is a center of a circle when the shape of the recess on the surface is circular, and is a center of a minimum circle that includes the shape of the surface when the shape is other than circular. The diameter a (mm), the center-to-center distance b (mm), and the depth d (μm) of the recess can be obtained from an image captured by an SEM.

The current collector sheet 21 is not limited as long as the arrangement pattern of the recesses in the region to be targeted satisfies the Expressions (1), (2), and (3). Targeted region may be the entire region of the surface of the current collector sheet 21 or a part of the region.

The arrangement pattern of the recesses may satisfy, for example, the relationship of Expressions (1a) and (2a):

$$0.08 \leq A \leq 0.14 \qquad ( 1 a )$$

$$B \leq 0.17 . \qquad ( 2 a )$$

The plurality of recesses can cause the Li metal to be deposited at a high density by satisfying the relationship of the average value D (μm) of the depth with Expression (3). The average value D (μm) of the depths of the recesses may further satisfy the relationship of Expression (4).

$$D / C \leq 4 / 5 \qquad ( 4 )$$

The surface of the current collector sheet 21 may be formed with a negative electrode mixture layer. The negative electrode mixture layer is formed, for example, by applying a paste containing a carbon material such as graphite or a negative electrode active material such as Si material to at least a part of the surface of the negative electrode current collector. The surface of the current collector sheet 21 may be coated with a metal coating. The metal coating may contain at least one metal selected from the group consisting of magnesium (Mg), aluminum (Al), zinc (Zn), silver (Ag), gold (Au), platinum (Pt), and tin (Sn).

FIG. 2 is a conceptual diagram showing an example of the current collector sheet in the present embodiment. FIG. 2 schematically shows an upper surface (one surface) of the current collector sheet 21. The current collector sheet 21 has a plurality of recesses 211. In the arrangement pattern shown in FIG. 2, in the recesses 211, except for the recesses 211 arranged on the outermost periphery, there are six other recesses 211 that are most adjacent. The recess 211 has a circular shape in a shape on the upper surface. The diameters of the recesses 211 are a constant diameter of a1 (mm) for each of the recesses 211, and the center-to-center distance between the recess 211 and the other recess 211 most adjacent to the recess 211 is a constant distance of b1 (mm). In the arrangement pattern shown in FIG. 2, an average value A (mm) of the diameters of the recesses 211 is a1 (mm), and an average value B (mm) of the center-to-center distances is b1 (mm).

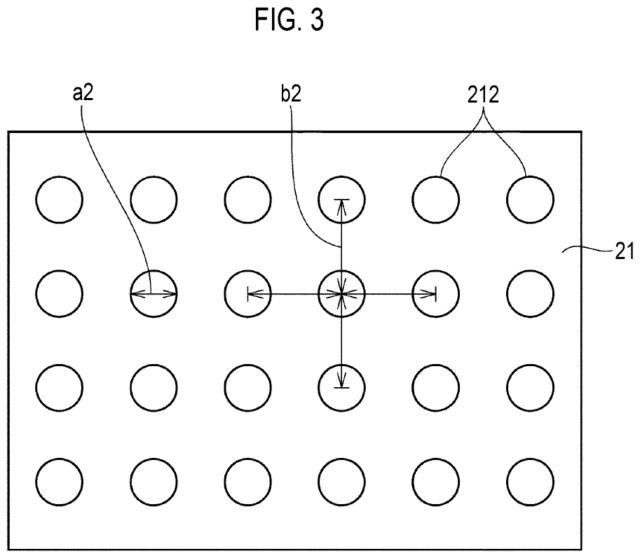

FIG. 3 is a conceptual diagram showing an example different from the current collector sheet of FIG. 2 in the present embodiment. FIG. 3 schematically shows an upper surface (one surface) of the current collector sheet 21. The current collector sheet 21 has a plurality of recesses 212. In the arrangement pattern shown in FIG. 3, the recesses 212 are arranged such that, except for the recesses 212 arranged on the outermost periphery, four other recesses 212 that are most adjacent to each other are present. The recess 212 has a circular shape in a shape on the upper surface. The diameters of the recesses 212 are a constant diameter of a2 (mm) for each of the recesses 212, and the center-to-center distance between the recess 212 and the other recess 212 most adjacent to the recess 212 is a constant distance of b2 (mm). In the arrangement pattern shown in FIG. 3, an average value A (mm) of the diameters of the recesses 212 is a2 (mm), and an average value B (mm) of the center-to-center distances is b2 (mm).

FIG. 1 shows the depths d (μm) of the recesses 211, 212. A depth d (μm) of each of the recesses 211, 212 is a distance in the thickness direction of the current collector sheet 21. For each of the recesses 211, 212, when the depth is not constant, the largest value is set as the depth of the recesses 211, 212.

The aperture ratio of the current collector sheet 21 in the present embodiment on one surface may be, for example, 20% to 60%, 20% to 45%, or 25% to 40%. The aperture ratio of the surface means a ratio of the total area of the surfaces of a plurality of recesses to an area occupied by one surface of the current collector sheet 21. For example, in the examples shown in FIGS. 2 and 3, the ratio of the total area of the recesses in the surfaces of a plurality of recesses 211, 212 formed in the current collector sheet 21 to the area occupied by the upper surface of the current collector sheet 21 is referred to.

The method of processing the current collector sheet 21 in the present embodiment to form a plurality of recesses is not limited, and the recesses can be formed by discharge processing, cutting processing, laser processing, or the like.

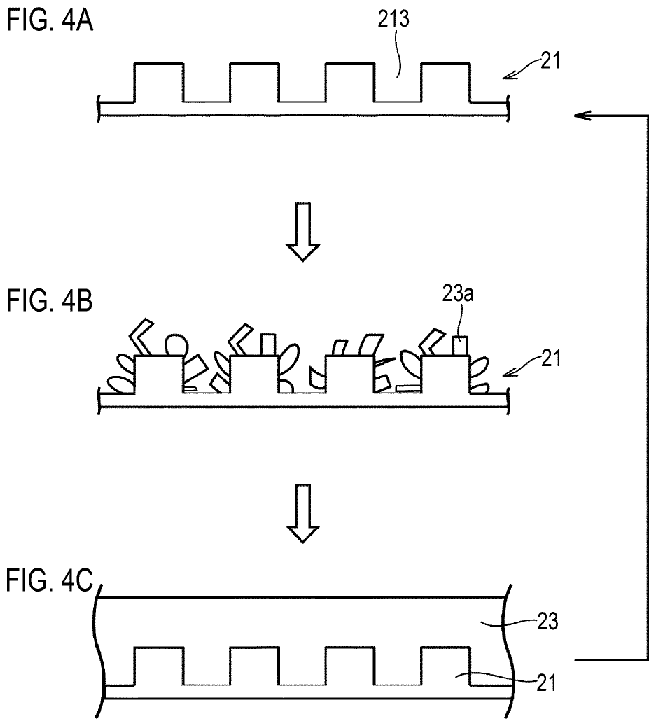

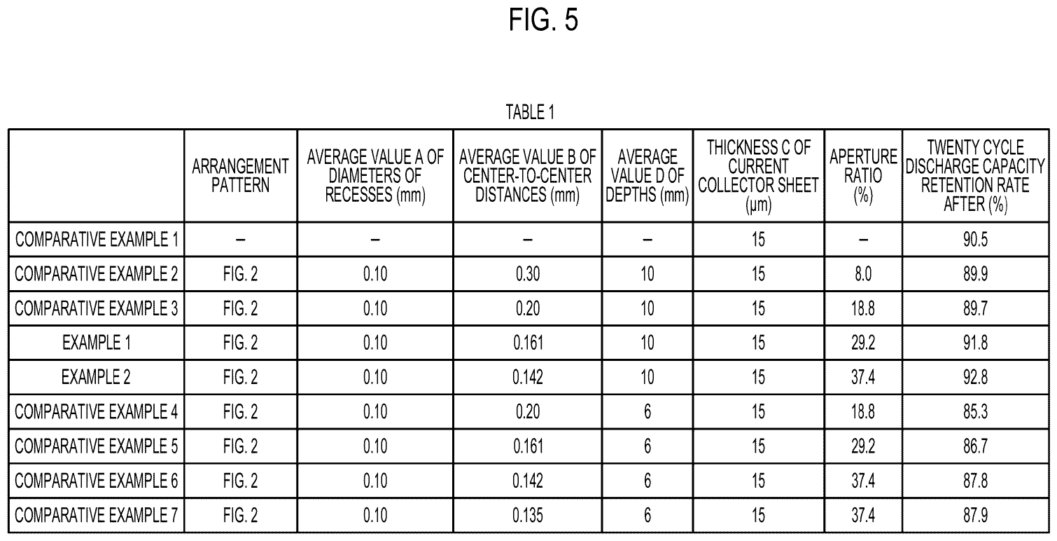

FIGS. 4A, 4B, and 4C are each a conceptual diagram showing a charging and discharging process of the negative electrode vicinity of the lithium secondary battery in the present embodiment. FIG. 4A shows an initial state. When the lithium secondary battery is charged from the initial state, as shown in FIG. 4B, lithium metal starts to be deposited from a plurality of origins of the current collector sheet 21 to form deposits 23a. The current collector sheet 21 has a plurality of recesses 213, and the inner wall of each of the plurality of recesses 213 also serves as an origin for the formation of the deposit 23a. When the charging is continued as it is, as shown in FIG. 4C, the deposit 23a that is deposited and grown from different origins is integrated to form the Li metal layer 23. Next, when the lithium secondary battery is discharged, the Li metal layer 23 is eluted. The Li metal layer 23 may be formed by integrating deposits, or may be formed of a plurality of deposits.

### Positive Electrode

The positive electrode 10 may be, for example, in a sheet shape. The positive electrode 10 may include, for example, a positive electrode base material 11 and a positive electrode active material layer 12. The positive electrode base material 11 has conductivity. The positive electrode base material 11 can function as a current collector. The positive electrode base material 11 supports the positive electrode active material layer 12. The positive electrode base material 11 may be, for example, in a sheet shape. The positive electrode base material 11 may have a thickness of, for example, 5 to 50 μm. The positive electrode base material 11 may include, for example, a metal foil. The positive electrode base material 11 may include, for example, at least one selected from the group consisting of aluminum (Al), manganese (Mn), titanium (Ti), iron (Fe), and chromium (Cr). The positive electrode base material 11 may include, for example, an Al foil, an Al alloy foil, a Ti foil, or an SUS foil.

### Electrolytic Solution

The electrolytic solution is a liquid electrolyte. The electrolytic solution contains a Li ion. The electrolytic solution may contain, for example, a solute and a solvent.

The concentration of the solute may be, for example, 0.5 mol/L to 1 mol/L, 1 mol/L to 1.5 mol/L, 1.5 mol/L to 2 mol/L, 2 mol/L to 2.5 mol/L, or 2.5 mol/L to 3 mol/L. The solute contains a supporting salt (Li salt). The solute may contain, for example, an inorganic salt, an imide salt, an oxalate complex, or a halide. The solute may include, for example, at least one selected from the group consisting of LiPF₆, LiBF₄, LiClO₄, LiAsF₆, LiSbF₆, LiN(SO₂F)₂ (common name: LiFSI), LiN(SO₂CF₃)₂ (common name: LiTFSI), LiB(C₂O₄)₂ (common name: LiBOB), LiBF₂(C₂O₄) (common name: LiDFOB), LiPF₂(C₂O₄)₂ (common name: LiDFOP), LiPO₂F₂, FSO₃Li, LiI, and LiBr, and derivatives thereof.

The electrolytic solution may contain, for example, an ether-based solvent. The solvent may include, for example, at least one solvent selected from the group consisting of tetrahydrofuran (THF), 1,4-dioxane (DOX), 1,3-dioxolane (DOL), 1,2-dimethoxyethane (DME), 1,2-diethoxyethane (DEE), ethyl glyme, triglyme, tetraglyme, hydrofluoroether (HFE), and derivatives thereof.

The battery 100 may include a gel electrolyte. The gel electrolyte contains an electrolytic solution and a polymer material. The polymer material may form a polymer matrix. The polymer material may include, for example, at least one selected from the group consisting of PVDF, PVDF-HFP, PAN, PVDF-PAN, polyethylene oxide (PEO), polyethylene glycol (PEG), and derivatives thereof.

### Separator

The separator 30 has electrical insulation properties. The separator 30 may include, for example, at least one selected from the group consisting of a resin film, an inorganic particle layer, and an organic particle layer. The separator 30 may include, for example, a resin film and an inorganic particle layer.

The resin film is porous. The resin film may include, for example, a microporous film or a nonwoven fabric. The resin film contains a resin skeleton. The resin skeleton may be, for example, continuously in a network. The pores are formed in the gaps of the resin skeleton. The resin film can allow the electrolytic solution to permeate. The resin film may have, for example, an average pore diameter of 1 μm or less. The resin film may have, for example, an average pore diameter of 0.01 μm to 1 μm or 0.1 μm to 0.5 μm. The “average pore diameter” can be measured by a mercury intrusion method. The resin film may have, for example, a Gurley value of 50 s/100 cm³ to 250 s/100 cm³. The “Gurley value” can be measured by a Gurley test method.

The resin film may include, for example, at least one selected from the group consisting of an olefin-based resin, a urethane-based resin, a polyamide-based resin, a cellulose-based resin, a polyether-based resin, an acrylic-based resin, and a polyester-based resin. The resin film may include, for example, at least one selected from the group consisting of polyethylene (PE), polypropylene (PP), polyamide (PA), polyamidoimide (PAI), polyimide (PI), aromatic polyamide (aramid), polyphenylene ether (PPE), and derivatives thereof. The resin film can be formed by, for example, a stretching method, a phase separation method, or the like. The resin film may have a thickness of, for example, 5μ m to 50 μm or 10 μm to 25μ m.

In the present embodiment, the configuration shown in the above-described embodiment in which the current collector sheet 21 has a plurality of recesses and the negative electrode 20 uses the dissolution deposition reaction of the lithium metal is adopted, and other configurations (combination of the positive electrode, the separator, and the electrolyte, and the like) are optional.

### Manufacture of Test Battery

Test batteries (anode-free batteries) according to Examples 1 and 2 and Comparative Examples 1 to 7 were manufactured by the following procedure. Hereinafter, for example, “the test battery according to Example 1” can be simply described as “Example 1”.

### Comparative Example 1

NCM as an active material, PVdF as a binder, and a conductive aid were mixed, and the obtained mixture was transferred to a container, and stirring (2000 rpm, for one minute) was performed in TALC (THINKY) three to four times. Then, N-methyl-2-pyrrolidone (NMP) was added while the viscosity was checked and the mixture was stirred until uniform (2000 rpm for five minutes). NMP was further added as needed and stirred (2000 rpm for two minutes). In this way, a slurry was obtained.

An aluminum foil (thickness: 16 μm) was prepared as a positive electrode base material. The slurry obtained above was applied onto an aluminum foil (thickness: 16 μm) by a doctor blade. As the doctor blade, a doctor blade having a gap of 350, 375, or 400 μm was used. The coating weight after solvent drying was measured, and the coating weight was adjusted to be about 23 mg/cm². Thereafter, the density was adjusted to 2.4 g/cc to 2.9 g/cc by roll pressing. Thereafter, the positive electrode was prepared by cutting the positive electrode mixture into a size of a coin cell (about 1.5 cm²) or a laminated cell (about 27 cm²).

As a separator, a resin film (thickness: 20 μm) was prepared. The resin film contained PP/PE.

As a negative electrode, a copper foil (thickness: 15 μm) was prepared. The copper foil was used as a current collector sheet without performing a process of forming the recesses and performing a metal coating.

The positive electrode, the separator, and the negative electrode were stacked in this order to form a power generation element. The power generation element was housed in the exterior body. The electrolytic solution was injected into the exterior body. The composition of the electrolytic solution was as follows.

### Composition of Electrolytic Solution

Solute: LiTFSI (1 mol/L)
Solvent: PC/FEC=7/3 (volume ratio)

After the electrolytic solution was injected, the exterior body was sealed. A test battery was manufactured as described above.

### Examples 1 and 2, and Comparative Examples 2 to 7

As a negative electrode, a copper foil (thickness: 15 μm) was prepared. The copper foil was formed with a plurality of recesses in an arrangement pattern shown in FIG. 2 by laser processing, and used as a current collector sheet. Table 1 of FIG. 5 shows the measured values regarding the arrangement pattern of the recesses and the shape of the recesses. The measured values shown in Table 1 of FIG. 5 are values calculated by measuring an SEM image of one surface of the current collector sheet. A test battery was manufactured in the same manner as in Comparative Example 1, except that a copper foil having a plurality of recesses was used as the current collector sheet.

### Evaluation

A cycle test under the following conditions was performed.
1. Rest: 60 min
2. CCCV Charging: (1/4) C (end current (1/100) C)
3. Rest: 5 min
4. CC Discharge: (1/4) C 3.0 V
5. Rest: 5 min
The number of cycles of 2. to 5.: 20

The 20-cycle discharge capacity retention rate was obtained by dividing the discharge capacity in the twentieth cycle by the discharge capacity in the first cycle. The 20-cycle discharge capacity retention rate is represented by a percentage.

### Results

Table 1 (FIG. 5) shows the 20-cycle discharge capacity retention ratio. It is considered that the cycle durability is better as the 20-cycle discharge capacity retention rate is higher. In the negative electrode current collector sheet, in Examples 1 and 2 in which a plurality of recesses were provided and the recesses satisfied the relationship of the Expressions (1) to (3), the cycle durability was improved as compared with Comparative Examples 1 to 7.

What is claimed is:

1. A lithium secondary battery comprising:
a positive electrode;
a separator;
a negative electrode; and
an electrolyte, wherein
the negative electrode includes a current collector sheet,
a thickness of the current collector sheet is 10 μm to 20 μm, and the current collector sheet includes a plurality of recesses, and
assuming that a diameter of each of the recesses on a surface is a (mm), a center-to-center distance between each of the recesses and another recess most adjacent to the recess is b (mm), and a depth of each of the recesses is d (μm), an average value of the diameters a (mm) is A (mm), an average value of the center-to-center distances b (mm) is B (mm), an average value of the depths d (μm) is D (μm), and a thickness of the current collector sheet is C (μm), relationships of Expressions (1), (2), and (3) are satisfied:
$$0.05 \leq A \leq 0.18 , \qquad ( 1 )$$
$$B \leq 0.18 , and \qquad ( 2 )$$
$$D / C \geq 3 / 5. \qquad ( 3 )$$

2. The lithium secondary battery according to claim 1, wherein the current collector sheet is a copper foil or a copper alloy foil.

3. The lithium secondary battery according to claim 1, wherein an aperture ratio of the surface of the current collector sheet is 20% to 45%.

4. The lithium secondary battery according to claim 1, wherein the lithium secondary battery is an anode-free battery.

5. The lithium secondary battery according to claim 1, wherein the current collector sheet is a copper foil or a copper alloy foil, and an aperture ratio of the surface is 20% to 45%.
